(19) United States
(12) Patent Application Publication
(10) Pub. No.: US 2003/0147590 A1
(43) Pub. Date: Aug. 7, 2003

(54) Low back reflection two-dimensional fiber array

(76) Inventor: Michael Hahn, Allentown, PA (US)

Correspondence Address: HITT GAINES P.C., P.O. BOX 832570, RICHARDSON, TX, 75083, US

(21) Appl. No.: 10/066,926

(22) Filed: Feb. 4, 2002

(51) Int. Cl. G02B 6/26

(52) U.S. Cl. 385/39

(57) ABSTRACT

The present invention is directed to a fiber optic or other waveguide array for transmitting electromagnetic energy that includes a substrate containing a plurality of substrate rows or layers, and at least one waveguide in each of the substrate layers, each of said waveguides having a waveguide central axis and a waveguide face for exiting the electromagnetic energy. The waveguide face is angled to the waveguide central axis and each of the waveguides are aligned parallel to each other in the substrate layers and at an offset angle to the substrate such that the electromagnetic energy exiting from each of the waveguide faces is substantially parallel to each other and substantially normal to the substrate.

### CROSS-REFERENCE TO RELATED APPLICATION

Not applicable.

### STATEMENT REGARDING FEDERALLY SPONSORED RESEARCH

Not applicable.

### REFERENCE TO MICROFICHE APPENDIX

Not applicable.

### BACKGROUND OF THE INVENTION

1. Field of the Invention

The present invention relates to a fiber optic array. More particularly, the present invention relates to a low back reflection two-dimensional fiber array. Even more particularly, the present invention involves a two dimensional fiber array comprising a plurality of substrate layers.

2. Description of the Prior Art

Waveguide arrays consist of a one or two dimensional array of a wave propagating material, such as a glass fiber, that are used to simultaneously transmit electromagnetic energy, such as microwaves, visible or infrared light. The most common waveguide arrays utilize optical fibers and transmit energy in the visible or near infrared portion of the spectrum. While fiber optic arrays are used in a wide variety of applications, one of the most significant uses of fiber arrays is in optical switches.

Typically, the fiber arrays are composed of a substrate, such as a “silicon optical bench” (SiOB), comprising embedded optical fibers, which form the array. The array is normally formed from a single substrate. Individual cavities or holes are etched into the substrate for placement of the fibers. This is typically accomplished using an RIE photolithographic process. The optical fibers are then inserted and the front face is polished after assembly.

The polished face is then typically coated with an antireflection coating in an effort to minimize reflective losses incurred as transmitted light crosses the array face.

The front face of the fiber array is also often polished at a fixed angle to the optical fibers, in an effort to reduce return loss due to backscattering.

However, these systems of the prior art have the distinct disadvantage that they cannot adequately reduce loss to industry standard in many applications, such as the aforementioned optical switching systems. The use of an anti-reflective coating, for example, can typically only achieve about 30 to 35 dB return loss, which is significantly less than the 50 to 55 dB that is normally required. Angling of the fiber array creates a variation in the spacing between the individual fibers and the receiving component, typically a lens or lens array, resulting in a variation of signal loss over individual channels. This is a critical disadvantage in optical switches.

Moreover, if the front face of the array is polished at an angle normal to the receiving lens to maintain a constant spacing, then the light does not leave the fibers at an angle normal to the fiber array plane, which creates undesired optical aberrations and beam steering due to the refraction of the light as it crosses the array boundary.

Accordingly, a fiber array is needed which will significantly reduce back reflection at the array interface, while adequately preventing a variation in signal loss and other optical aberrations, such as beam steering.

### SUMMARY OF THE INVENTION

The present invention is directed to a fiber optic or other waveguide array for transmitting electromagnetic energy that includes a substrate containing a plurality of substrate rows or layers, and at least one waveguide in each of the substrate layers, each of said waveguides having a waveguide central axis and a waveguide face for transmitting the electromagnetic energy. The waveguide face is angled to the waveguide central axis with each of the waveguides being aligned parallel to each other in the substrate layers and at an offset angle to the substrate such that the electromagnetic energy transmitted from each of the waveguide faces is substantially parallel to each other and substantially normal to the substrate.

### BRIEF DESCRIPTION OF THE DRAWINGS

FIGS. 1(a) and 1(b) are cross-section elevations illustrating the inadequate fiber arrays of the prior art.

FIG. 2 is a cross-section elevation illustrating a preferred embodiment of the fiber array of the present invention.

FIG. 3 is an isometric drawing of a preferred embodiment of the fiber array of the present invention.

### DETAILED DESCRIPTION OF THE PREFERRED EMBODIMENT

The present invention will be understood more fully from the detailed description given below and from the accompanying drawings of preferred embodiments of the invention, which, however, should not be taken to limit the invention to a specific embodiment, but are for explanation and understanding only.

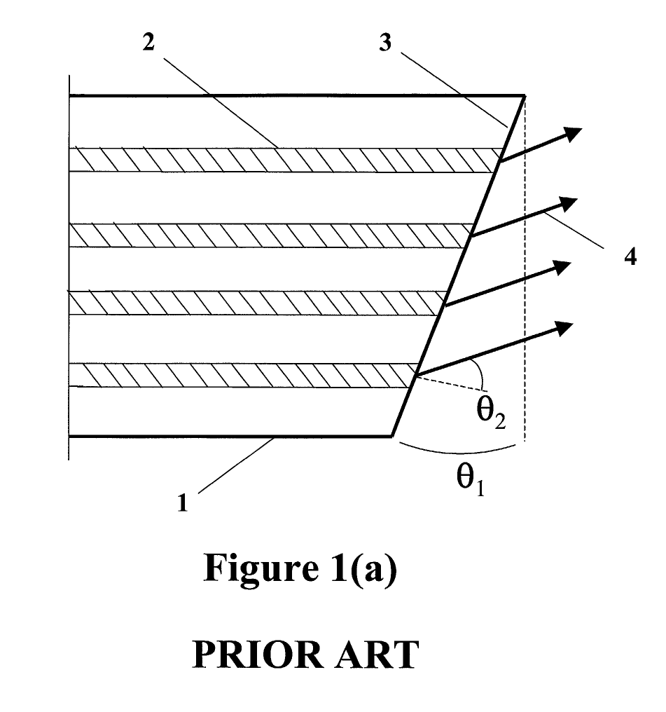

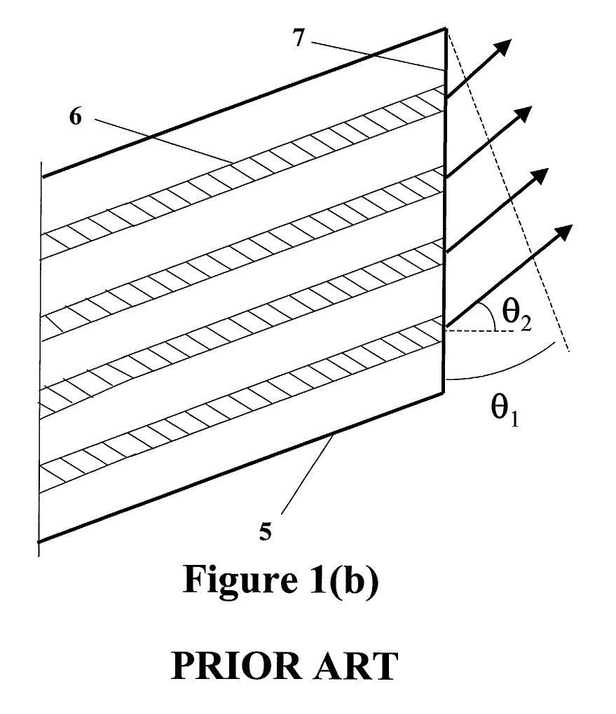

The fiber optic array systems of the prior art are illustrated in FIGS. 1(a) and 1(b). In the prior art system shown in FIG. 1(a), a fiber array comprises Substrate 1, into which Optical Fibers 2 are embedded. Substrate 1 typically comprises an SiOB or the like, formed by conventional RIE, photolithography, and similar processes. Optical Fibers 2 may comprise Silica, polymers, or similar materials well known to those of skill in the art. Optical Fibers may be one or more or any of a number of well-known types of fiber, such as single mode, multi-mode, or graded-index (“GRIN”) fibers. Optical Fibers 2 are integrated into Substrate 1 as a single unit, having Array Face 3. The composition and manufacture of such a system is well known to those of ordinary skill in the art.

Array Face 3 is conventionally polished at Angle θ₁ from a position normal to Optical Fiber 2 and to the receiving lens or other component (not shown). Typically, Angle θ₁ is approximately 8° or so. The angling of Array Face 3 increases the angle of incidence of a greater portion of the light transmitted along Optical Fiber 2 at the boundary of Array Face 3, resulting in the transmission of more light through the interface and less backscatter. Because Array Face 3 is an interface between different media having different refractive indices, Light 4 exiting from Array Face 3 is also refracted at Refraction Angle θ₂. The angling of Array Face 3 by Angle θ₁ also reduces the angle at which the exiting light subsequently impinges upon the receiving lens by the amount θ₂-θ₁.

While the gap created between Array Face 3 and the receiving component may also be filled with a matching gel, having a refractive index close to that of Optical Fibers 2 and/or the receiving lens in an attempt to minimize the angle of refraction of the light as it leaves Array Face 3, this is undesirable or not possible in many applications, such as optical switching, due to difficulties in maintaining consistency in the gel and in manufacturing and operating the manufactured system.

As illustrated in FIG. 1(a), because Array Face 3 is polished at Angle θ₁, light exiting from optical fibers at one end of Array Face 3 has to travel a greater distance than light exiting optical fibers at the other end of Array Face 3. This discrepancy causes a variation in the of signal loss across the optical fibers, as previously noted. A variation in signal loss is particularly detrimental in optical switches as it will greatly reduce switching speed and increase error rates in transmitted data streams.

In the prior art fiber array shown in FIG. 1(b), Substrate 5 contains Optical Fibers 6, manufactured in a manner similar to the prior art array shown in FIG. 1(a). In this prior art system, Array Face 7 is kept normal to the receiving component. Array Face 7 is still polished at an angle, however, in relation to each of Optical Fibers 6 to reduce backscatter. This configuration eliminates the varying gap created by the angling of the array face, but effectively increases the angle at which Light 4 is incident upon the receiving lens to by the amount θ₂+θ₁. This angle can be 11.8° or more. This results in significant optical aberrations and beam steering, as previously noted.

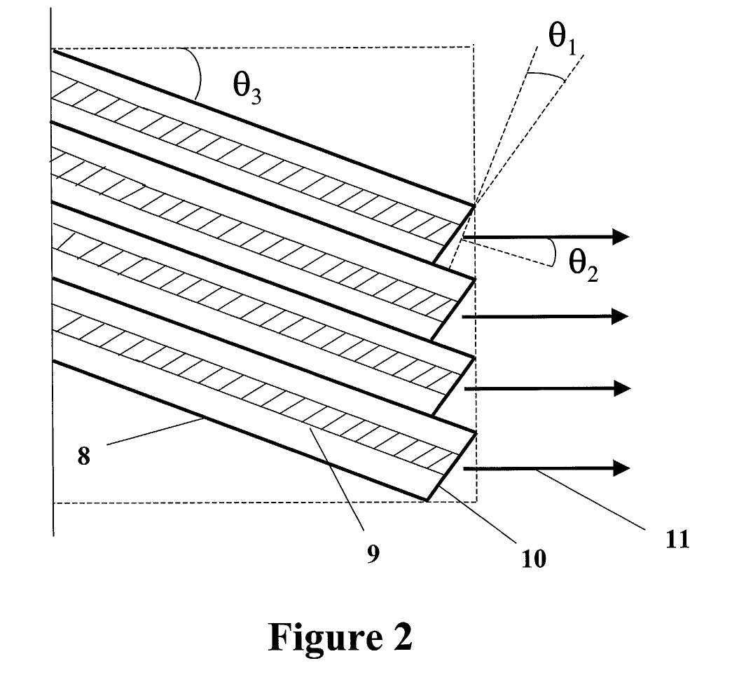

In sharp contrast, the fiber array of the present invention is shown in FIG. 2. As shown in FIG. 2, Substrate Rows 8 are each embedded with Optical Fibers 9. The substrate and optical fibers are not particularly limited, and may comprise the same or similar types of materials described above in regard to the systems of the prior art. The manufacture of each of Substrate Rows 8 may also be accomplished in the manner of the fiber arrays of the prior art, which are well known to those of skill in the art, such as through RIE and photolithographic processes.

Each of Substrate Rows 8 has a Row Face 10. Preferably, the face of Optical Fiber 9 is polished at Angle θ₁ to the central axis of the fiber. Individual Substrate Rows 8 are then preferably stacked together in the staggered configuration shown in FIG. 2, so that each of Optical Fibers 9 in Substrate Row 8 is parallel to each of Optical Fibers 9 in each other Substrate Row 8. All of Substrate Rows 8 are preferably configured at an Offset Angle θ₃ from normal. Offset Angle θ₃ and the Angle θ₁ of Row face 10 are not particularly limited, but are calculated to offset the refraction of light exiting the array at Refraction Angle θ₂. In the example shown, if θ₁ were about 8°, then θ₃ would typically have to be about 3.8° in array composed of silica glasses.

As a result, each Row Face 10 is angled to the receiving lens or other component (not shown) by the amount of θ₃+θ₁, which is approximately equal θ₂, resulting in light exiting the array substantially normal to the array face. In addition, because each of Substrate Rows 8 are parallel to each other, the gap distance between Row Face 10 and the receiving lens is the same for all of Optical Fibers 9.

The configuration of the fiber array of the present invention achieves significant benefits over the systems of the prior art. In the present invention, all of Light 11 exiting from each of Optical fibers 9 is incident upon the receiving lens at an angle of approximately 90°. In other words, Refraction Angle θ₂ is substantially eliminated. Moreover, there is no variation in the gap between the optical fibers and the receiving lens array, which substantially eliminates variations in signal loss, and helps to ensure that all signal loss is uniform. This is particularly advantageous in optical switching systems, where non-uniformity in signal loss can significantly reduce switching speed and increase error rates through the introduction of optical aberrations.

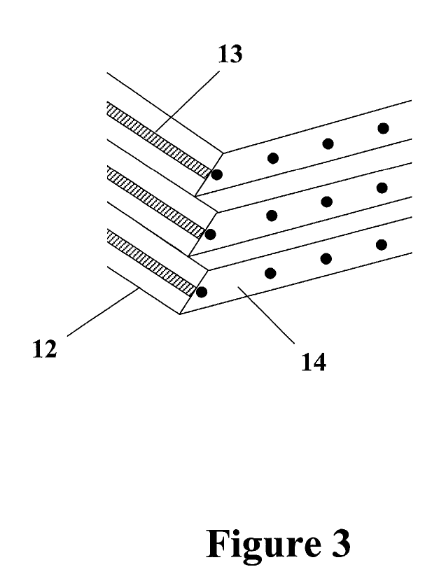

A further illustration of the preferred embodiment of the present invention is shown in FIG. 3. As shown in FIG. 3, individual Array Rows 12 each contain one or more Optical Fibers 13, which are created separately in a conventional manner and then stacked upon each other, as shown. Each Array Row 12 has a Row Face 14, which is angled by an amount equal to Offset Angle θ₃, as previously noted.

While the size of the array of the present invention is not particularly limited, it is preferably an 8×10 glass fiber array, with approximately 1¼ mm between the fibers with a front face of 10×12½ mm. The substrate is silicon and is preferably 285 microns of thickness, but is not limited thereto.

Each of the substrate rows in the present invention is preferably manufactured separately and then stacked together in the manner previously described. The stacking configuration of the present invention is not particularly limited and can comprise any number of well known configurations, such as the use of a tongue in groove for alignment of the layers.

Although this invention has been described with reference to particular embodiments, it will be appreciated that many variations may be resorted to without departing from the spirit and scope of this invention. For example, the waveguide array of the present invention can be used to transmit infrared, optical, and microwave energy and can utilize other types of waveguide, such as channel waveguides and the like, in addition to optical fibers. Moreover, for example, the substrate of the present invention is not limited to a SiOB, but can comprise any waveguide substrate, such as metalized substrates comprising Al₂O₃, and the like.

1. A waveguide array for transmitting electromagnetic energy comprising:
a plurality of substrate rows; and
at least one waveguide in each of said plurality of substrate rows, each of said waveguides having a central axis and a waveguide face for transmitting said electromagnetic energy, said waveguide face being angled to said waveguide central axis;
wherein each of said waveguides are aligned substantially parallel to each other in said substrate rows and at an offset angle to said waveguide array; and
wherein said offset angle and said angle of said waveguide face are such that said electromagnetic energy transmitted from each of said waveguide faces is substantially parallel to each other and substantially normal to said waveguide array.

2. The waveguide array of claim 1, wherein said waveguide comprises an optical fiber.

3. The waveguide array of claim 2, wherein said optical fiber comprises of one or more selected from the group consisting of glass and polymers.

4. The waveguide array of claim 1, wherein said substrate rows comprise one or more selected from the group consisting of silicon, ceramics, and metal oxides.

5. The waveguide array of claim 1, wherein said electromagnetic energy comprises one or more selected from the group consisting of microwaves, visible light, and infrared radiation.

6. A fiber optic array comprising:
a plurality of substrate rows; and
at least one optical fiber in each of said plurality of substrate rows for transmitting light, each of said optical fibers having a central axis and a face for transmitting said light, said optical fiber face being angled to said optical fiber central axis;
wherein each of said optical fibers are aligned substantially parallel to each other in said substrate rows and at an offset angle; and
wherein said offset angle and said angle of said fiber face are such that said light transmitted from each of said optical fiber faces is substantially parallel to each other and substantially normal to said fiber array.

7. The fiber array of claim 6, wherein said optical fiber comprises one or more selected from the group consisting of glass and polymers.

8. The fiber array of claim 5, wherein said optical fiber is one or more selected from the group consisting of single mode fibers, multi-mode fibers, and grated index fibers.

9. The fiber array of claim 5, wherein said substrate layers comprise one or more selected from the group consisting of silicon, ceramics, and metal oxides.

10. A method for transmitting electromagnetic energy in a waveguide array comprising the steps of:
creating a plurality of substrate rows;
embedding at least one waveguide in each of said plurality of substrate rows, wherein each of said waveguide has a central axis and a waveguide face for transmitting said electromagnetic energy;
forming and said waveguide face at an angle to said waveguide central axis; and
aligning each of said waveguides in each of said plurality of substrate rows substantially parallel to each other and at an angle offset to said waveguide array, such that said electromagnetic energy transmitted from each of said waveguide faces is substantially parallel to each other and substantially normal to said waveguide array.

11. The method of claim 10, wherein said waveguide comprises an optical fiber.

12. The method of claim 11, wherein said optical fiber comprises one or more selected from the group consisting of glass and polymers.

13. The method of claim 10, wherein said substrate rows comprise one or more selected from the group consisting of silicon, ceramics, and metal oxides.

14. A method for transmitting electromagnetic energy in a fiber optic array comprising the steps of:
creating a plurality of substrate rows;
embedding at least one optical fiber in each of said plurality of substrate rows, each of said optical fibers having a central axis and a fiber face for transmitting said light;
forming said fiber face at an angle to said central axis; and
aligning each of said optical fibers in said substrate rows substantially parallel to each other and at an offset angle to said fiber array such that light transmitted from each of said fiber faces is substantially parallel to each other and substantially normal to said fiber array.

15. The method of claim 14, wherein said optical fiber comprises one or more selected from the group consisting of glass and polymers.

16. The method of claim 14, wherein said optical fibers are one or more selected from the group consisting of single mode fibers, multi-mode fibers, and grated index fibers.

17. The method of claim 14, wherein said substrate rows comprise one or more selected from the group consisting of silicon, ceramics, and metal oxides.
